(19) United States
(12) Patent Application Publication
(10) Pub. No.: US 2025/0109068 A1
(43) Pub. Date: Apr. 3, 2025

(54) REBAR-FREE PRESTRESSED CONCRETE AND FORMING METHOD THEREFOR

(71) Applicant: CHINA BUILDING MATERIALS ACADEMY CO., LTD., Beijing (CN)

(72) Inventors: Zhendi WANG, Beijing (CN); Ling WANG, Beijing (CN)

(21) Appl. No.: 18/862,003

(22) PCT Filed: Jul. 4, 2023
(86) PCT No.: PCT/CN2023/105648

§ 371 Date: Oct. 31, 2024

(30) Foreign Application Priority Data
May 5, 2022 (CN) 202210481648.X

(51) Int. Cl. C04B 28/04; B32B 13/02; B32B 13/04; C04B 14/04; C04B 14/28; C04B 14/30; C04B 14/34; C04B 14/36; C04B 18/08; C04B 18/14; C04B 22/08; C04B 22/12; C04B 22/14; C04B 24/02; C04B 24/12; C04B 24/26; C04B 24/32; C04B 103/30; C04B 111/34; E04C 5/08

(52) U.S. Cl. CPC C04B 28/04; B32B 13/02; B32B 13/04; C04B 14/048; C04B 14/28; C04B 14/304; C04B 14/34; C04B 14/36; C04B 18/08; C04B 18/141; C04B 18/146; C04B 22/085; C04B 22/124; C04B 22/147; C04B 24/02; C04B 24/122; C04B 24/2641; C04B 24/32; E04C 5/08; C04B 2103/302; C04B 2111/34

(57) ABSTRACT

The present disclosure relates to an rebar-free prestressed concrete and a forming method therefor. The unreinforced prestressed concrete includes: a base layer, which is a mortar, concrete or neat paste pouring piece, where the base layer has a deformation value S1; and a prestressed layer disposed on a surface of the base layer and completely covering the base layer. The prestressed layer is a mortar, concrete or neat paste pouring piece, and does not include a steel bar. The prestressed layer has a deformation value S2, where S1 is smaller than S2. The solved technical problem is how to achieve an unreinforced prestressed concrete having a prestressed surface layer without the use of steel bar tensionsing, allowing same to improve the crack resistance and durability of a building without increasing new investment, reducing construction costs without bringing about fire hazards, and thus improving suitability for practical use.

### CROSS REFERENCE TO RELATED APPLICATION

This application claims priority to Chinese Patent Application No. 202210481648.X titled “REBAR-FREE PRESTRESSED CONCRETE AND FORMING METHOD THEREFOR” and filed to the State Patent Intellectual Property Office on, the entire contents of which are incorporated herein by reference.

### TECHNICAL FIELD

The present disclosure relates to the field of civil engineering and transportation technology, and more particularly, to an rebar-free prestressed concrete and a forming method therefor.

### BACKGROUND

A prestressed concrete is a structure that is precompressed before load effects are applied, and its prestress is generated by tensioning high-tensile steel bars or wires. There are two methods of tensioning: 1) a pre-tensioning method, in which a steel bar is first tensioned, then the concrete is poured, and then two ends of the steel bar are loosened when the concrete reaches a specified strength; and 2) a post-tensioning method, in which the concrete is first poured, then the steel bar that passes through a reserved hole in the concrete is tensioned when the specified strength is reached, and then the steel bar is anchored at its two ends. The prestress generated by the tensioning of the steel bar is used to reduce or offset a tensile stress caused by external loads. That is, the insufficient tensile strength of the concrete is compensated for by means of its higher compressive strength, to achieve the objective of delaying cracking destruction of the concrete in a tensile zone. Moreover, due to the prestress applied to the concrete in advance, occurrence of cracks is greatly delayed. Under the action of the load, the cracks do not appear in a member, or occurrence of the cracks may be delayed. In this way, rigidity of the member is improved, durability of the concrete is increased, material consumption is saved and a sectional dimension is reduced, which is advantageous to reducing carbon emissions.

However, the above-mentioned ordinary prestressed concrete also has following defects. First, its construction requires tensioning of the steel bar, the construction process is complex, and specialized tensioning equipment is needed for construction, resulting in higher start-up costs and higher costs for projects with a small number of members. Second, under high temperature conditions, the strength of the prestressed steel bar may significantly decrease, leading to reduction in duration of fire resistance, which poses a safety hazard to building fire protection.

### SUMMARY

A main objective of the present disclosure is to provide an rebar-free prestressed concrete and a forming method therefor. A solved technical problem is how to achieve the unreinforced prestressed concrete having a prestressed surface layer without the use of steel bar tensionsing, allowing the same to improve the crack resistance and durability of a building without increasing new investment, reducing construction costs without bringing about fire hazards, and thus improving suitability for practical use.

The objective of the present disclosure and the solved technical problem are achieved through the following technical solutions. An unreinforced prestressed concrete proposed according to the present disclosure includes:
a base layer, which is a mortar, concrete or neat paste pouring piece, where the base layer has a deformation value S1; and
a prestressed layer disposed on a surface of the base layer and completely covering the base layer, where the prestressed layer is a mortar, concrete or neat paste pouring piece, and does not include a steel bar; and the prestressed layer has a deformation value S2, S1<S2.

The objective of the present disclosure and the solved technical problem may also be achieved by adopting the following technical measures.

Preferably, in the above unreinforced prestressed concrete, the base layer shrinks, and the prestressed layer expands.

Preferably, in the above unreinforced prestressed concrete, the base layer shrinks, the prestressed layer shrinks, and shrinkage of the base layer is greater than that of the prestressed layer.

Preferably, in the above unreinforced prestressed concrete, the base layer expands, the prestressed layer expands, and expansion of the base layer is smaller than that of the prestressed layer.

Preferably, the above unreinforced prestressed concrete sequentially includes a prestressed layer, a base layer, and a prestressed layer.

The objective of the present disclosure and the solved technical problem are also achieved through the following technical solutions. A method for forming the unreinforced prestressed concrete proposed according to the present disclosure includes:
forming the base layer; measured by weight percentage content, the base layer has a formula as follows: binding material cement 3.5%˜65%, water 6%˜20%, fine aggregate 0.2%˜54%, coarse aggregate 0%˜43%, water reducer 0.09%˜1.4%, ultrafine mineral admixture 4%˜18%, early strength agent 0.02%˜1.4%, expanding agent 0%˜0.7%, shrinkage reducing agent 0%˜0.06%, thickener 0%˜0.06%, and accelerating agent 0%˜0.06%; the deformation value of the base layer is represented by S1; and
forming the prestressed layer; measured by the weight percentage content, the base layer has a formula as follows: binding material cement 4.8%˜58%, water 6%˜20%, fine aggregate 0.6%˜54%, coarse aggregate 0%˜47%, water reducer 0.09%˜1.4%, admixture 4%˜20%, shrinkage reducing agent 0%˜2%, expanding agent 0.06%˜5%, thickener 0%˜0.06%, and accelerating agent 0%˜0.06%; the prestressed layer does not include a steel bar and completely covers the base layer; the deformation value of the prestressed layer is represented by S2, where S1<S2.

The objective of the present disclosure and the solved technical problem may also be achieved by adopting the following technical measures.

Preferably, the method includes: 1) forming the base layer; 2) pouring the prestressed layer on the base layer; and 3) after demoulding, exposing the prestressed layer for service.

Preferably, the method includes: 1) forming the prestressed layer; 2) pouring the base layer on the prestressed layer; and 3) flipping after demoulding, such that the prestressed layer is exposed for service.

Preferably, the method includes: 1) forming the prestressed layer; 2) pouring the base layer on the prestressed layer; 3) pouring the prestressed layer on the base layer; and 4) after demoulding, exposing the prestressed layer for service.

Preferably, in the aforementioned method, the binding material cement is selected from at least one of general purpose portland cement, special cement, and an air-hardening binding material.

Preferably, in the aforementioned method, the water reducer is selected from at least one of a polycarboxylate water reducer, a naphthalene water reducer, an anthracene water reducer, and a melamine water reducer.

Preferably, in the aforementioned method, the admixture is selected from at least one of fly ash, slag, stone powder, steel slag powder, and limestone powder.

Preferably, in the aforementioned method, the shrinkage reducing agent is at least one of a polyether or polyalcohol organic matter and a derivative thereof.

Preferably, in the aforementioned method, the expanding agent is selected from at least one of a calcium sulfoaluminate type expanding agent, a magnesium oxide-based expanding agent, a lime-based expanding agent, and an iron powder series expanding agent.

Preferably, in the aforementioned method, a specific surface area of the ultrafine mineral admixture is great than or equal to 500 m2/kg, and the ultrafine mineral admixture is selected from at least one of ultrafine slag, ultrafine cement, silica fume, ultrafine limestone powder, and ultrafine fly ash.

Preferably, in the aforementioned method, the early strength agent is selected from at least one of sodium sulfate, potassium sulfate, potassium chloride, sodium chloride, sodium silicate, sodium nitrate, sodium acetate, triethanolamine, and methanol.

By means of the above technical solutions, the present disclosure proposes an rebar-free prestressed concrete and a forming method therefor, which have at least following advantages.

In the unreinforced prestressed concrete and the forming method thereof proposed by the present disclosure, the deformation value of the base layer and the deformation value of the prestressed layer are reasonably adjusted by controlling a mutual relationship between the formula of the base layer and the formula of the prestressed layer, such that the deformation value of the base layer is smaller than that of the prestressed layer, thereby generating the compressive prestress in the prestressed layer. That is, it is obtained the unreinforced prestressed concrete whose surface layer is compressed. In one aspect, manufacturing costs of the prestressed concrete are reduced, and there is no need to use a tensioning material such as the steel bar, which saves both material costs of the tensioned steel bar and construction and labor costs of tensioned steel bar. In another aspect, it is not required to use the tensioning material such as the steel bar, so reduction in duration of fire resistance caused by significant decrease in the strength of the steel bar may be prevented, which may most likely eliminate potential safety hazard to building fire protection. According to the technical solutions of the present disclosure, by reasonably designing the formula of the concrete of the base layer and the formula of the concrete of the prestressed layer, the prestressed concrete whose surface layer is compressed may be obtained without using the tensioned steel bar. The prestress of the surface layer of the prestressed concrete is not as high as the prestress generated by the tensioned steel bar. However, if the prestressed concrete is applied to applications with certain prestress requirements, crack resistance and durability of a building can be improved without increasing new investments, construction costs can be reduced, and no fire hazard is incurred, thereby achieving better comprehensive effects.

The above description is merely an overview of the technical solutions of the present disclosure. To more clearly understand technical means of the present disclosure and implement them in accordance with contents of the specification, preferred embodiments of the present disclosure are described in detail below.

### BRIEF DESCRIPTION OF THE DRAWINGS

### DETAILED DESCRIPTION

To further elaborate on the technical means adopted in the present disclosure to achieve predetermined inventive objectives and effects thereof, specific implementation manners, structures, features, and effects of an rebar-free prestressed concrete and a forming method therefor proposed according to the present disclosure will be described in detail below, in conjunction with preferred embodiments.

The present disclosure proposes an unreinforced prestressed concrete, including: a base layer, which is a mortar, concrete or neat paste pouring piece, where the base layer has a deformation value S1; and a prestressed layer disposed on a surface of the base layer and completely covering the base layer, where the prestressed layer is a mortar, concrete or neat paste pouring piece, and does not include a steel bar. The prestressed layer has a deformation value S2, S1<S2.

In the above technical solutions, technical means such as reinforcement tension are not used, only by controlling the deformation value of the base layer and of the prestressed layer and ensuring the deformation value of the base layer to be smaller than that of the prestressed layer, a certain degree of prestress is generated in the prestressed layer, thereby achieving compression of concrete surface and improving comprehensive performance.

In the above technical solutions, the deformation value refers to a differential obtained by subtracting an initial size of the base layer or prestressed layer from a final size thereof. The deformation value is tested using a contact method or non-contact method in GB/T50082. When the concrete is in a state of shrinkage, its deformation value is a negative number, which is also referred to as a shrinkage value. Otherwise, when concrete is in a state of expansion, its deformation value is a positive number, which is also referred to as an expansion value. A prestress situation of the prestressed layer may be classified into several types depending on the formula of the base layer and the formula of the prestressed layer.

S1 is a negative number when the formula of the base layer causes the shrinkage of the base layer. S2 is a positive number when the formula of the prestressed layer causes the expansion of the prestressed layer. In this case, the prestress in the prestressed layer is generated by the sum of absolute values of S1 and S2.

S1 is a negative number when the formula of the base layer causes the shrinkage of the base layer. S2 is a negative number when the formula of the prestressed layer causes the shrinkage of the prestressed layer. In this case, it is required that the shrinkage of the base layer is greater than that of the prestressed layer, that is, S1<S2. At this moment, the prestress of the prestressed layer is generated by the differential between the absolute values of S1 and S2.

S1 is a positive number when the formula of the base layer causes the expansion of the base layer. S2 is a positive number when the formula of the prestressed layer causes the expansion of the prestressed layer. In this case, it is required that the expansion of the base layer is smaller than that of the prestressed layer, that is, S1<S2. At this moment, the prestress of the prestressed layer is generated by the differential between the absolute values of S1 and S2.

In the above technical solutions, the prestress exerted into the prestressed layer may be calculated according to the following formula:

the prestress=(S2−S1)×E2

In the formula, S1 represents the deformation value of the base layer, S2 represents the deformation value of the prestressed layer, and S1 and S2 are unitless; E2 represents elastic modulus of the prestressed layer, and is expressed in units of Mpa; and the prestress is also expressed in units of Mpa.

The unreinforced prestressed concrete described in the present disclosure may also be manufactured into a sandwich structure having three layers of concrete, which sequentially includes: a prestressed layer, a base layer, and a prestressed layer. The prestressed layer is disposed on the surface of the base layer and is exposed to outside for service.

The present disclosure also proposes a method for forming the unreinforced prestressed concrete, comprising following steps of:
forming the base layer; measured by weight percentage content, the base layer has a formula as follows: binding material cement 3.5%˜65%, water 6%˜20%, fine aggregate 0.2%˜54%, coarse aggregate 0%˜43%, water reducer 0.09%˜1.4%, ultrafine mineral admixture 4%˜18%, early strength agent 0.02%˜1.4%, expanding agent 0%˜0.7%, shrinkage reducing agent 0%˜0.06%, thickener 0%˜0.06%, and accelerating agent 0%˜0.06%; the deformation value of the base layer is represented by S1; and
forming the prestressed layer; measured by the weight percentage content, the base layer has a formula as follows: binding material cement 4.8%˜58%, water 6%˜20%, fine aggregate 0.6%˜54%, coarse aggregate 0%˜47%, water reducer 0.09%˜1.4%, admixture 4%˜20%, shrinkage reducing agent 0%˜2%, expanding agent 0.06%˜5%, thickener 0%˜0.06%, and accelerating agent 0%˜0.06%; the prestressed layer does not include a steel bar and completely covers the base layer; the deformation value of the prestressed layer is represented by S2, where S1<S2.

Magnitude of the prestress applied to the prestressed layer of the concrete described according to the present disclosure may be specifically adjusted according to the formula of the base layer and of the prestressed layer. When the prestressed layer is subjected to a larger prestress, to avoid defects such as cracking of the base layer due to tension, thickness of the base layer may be increased or internal reinforcement of the base layer may be provided for prevention.

In the step of forming the unreinforced prestressed concrete, the base layer may be formed prior to the prestressed layer, or the prestressed layer may be formed prior to the base layer. No matter the prestressed layer is formed prior or posterior to the base layer, the prestressed layer is exposed to the outside for service.

Specifically, when the unreinforced prestressed concrete has a two-layer structure, the method of the present disclosure includes following steps: 1) forming the base layer; 2) pouring the prestressed layer on the base layer; and 3) after demoulding, exposing the prestressed layer for service. Alternatively, the method of the present disclosure includes following steps: 1) forming the prestressed layer; 2) pouring the base layer on the prestressed layer; and 3) flipping after demoulding, such that the prestressed layer is exposed for service.

When the unreinforced prestressed concrete has a three-layer structure, the method of the present disclosure includes following steps: 1) forming the prestressed layer; 2) pouring the base layer on the prestressed layer; 3) pouring the prestressed layer on the base layer; and 4) after demoulding, exposing the prestressed layer for service.

The step of forming the unreinforced prestressed concrete also includes a step of carrying out interface treatment between the base layer and the prestressed layer, which is intended to ensure strong bonding between the two layers, to ensure that the base layer and the prestressed layer can be firmly bonded into a whole.

The interface treatment includes spraying an emulsion-type interfacial agent at an interface, or arranging metal fiber at the interface such that the metal fiber is inserted into the base layer and the prestressed layer simultaneously. When the metal fiber is arranged, a step of surface galling may also be performed on the base layer or the prestressed layer.

The binding material cement in the formula of the present disclosure includes, but is not limited to, at least one of general purpose portland cement, special cement, an air-hardening binding material, and a hydraulic binding material, which mainly plays a role of binding.

The water mentioned in the formula of the present disclosure is mixing water, which is added during construction mixing.

The coarse aggregate and the fine aggregate mentioned in the formula of the present disclosure include, but are not limited to, at least one of machine-made sand, natural river sand, recycled aggregate, and any other materials that can serve as cement-based aggregates.

The water reducer in the formula of the present disclosure includes, but is not limited to, at least one of a polycarboxylate water reducer, a naphthalene water reducer, an anthracene water reducer, and a melamine water reducer.

As an auxiliary binding material, the admixture in the formula of the present disclosure includes, but is not limited to, a mixture of at least one of auxiliary binding materials having filling effects or volcanic ash effects, such as fly ash, slag, stone powder, steel slag powder, and limestone powder.

The shrinkage reducing agent in the formula of the present disclosure is used to reduce surface tension of water in a cement capillary and reduce macroscopic shrinkage of the concrete. Selected from at least one of a polyether or polyalcohol organic matter and a derivative thereof, the shrinkage reducing agent can regulate the shrinkage/expansion deformation of the unreinforced prestressed concrete. Based on the design of a two-layer formula, the degree of shrinkage or expansion deformation of the base layer or prestressed layer can be controlled, and then a state of surface layer compression of the prestressed layer can be achieved. In this way, the unreinforced prestressed concrete is prepared.

The expanding agent in the formula of the present disclosure is used to reduce shrinkage of the concrete and cause the concrete to form the expansion deformation. The expanding agent includes, but is not limited to, at least one of a calcium sulfoaluminate type expanding agent, a magnesium oxide-based expanding agent, a lime-based expanding agent, and an iron powder series expanding agent. The expanding agent can regulate the shrinkage/expansion deformation of the unreinforced prestressed concrete such that the expansion of the prestressed layer is greater than that of the base layer, and then the state of surface layer compression of the prestressed layer can be achieved. In this way, the unreinforced prestressed concrete is prepared.

A specific surface area of the ultrafine mineral admixture in the formula of the present disclosure exceeds 500 m2/kg, and the ultrafine mineral admixture includes, but is not limited to, at least one of ultrafine slag, ultrafine cement, silica fume, ultrafine limestone powder, and ultrafine fly ash. In conventional techniques, for example, the ultrafine mineral admixture is added to ordinary concrete, which is mainly intended to improve strength of the concrete. That is, the strength of the concrete can be improved by replacing a portion of cement with the ultrafine mineral admixture in equal proportion. In the present disclosure, some ultrafine mineral admixtures are added to the formula of the concrete of the base layer to increase the shrinkage of the concrete of the base layer. In this way, it is controlled that the shrinkage of the base layer can be greater than that of the prestressed layer, or that the base layer shrinks but the prestressed layer expands. Thus, prestress is generated in the prestressed layer.

The early strength agent in the formula of the present disclosure includes, but is not limited to, at least one of sodium sulfate, potassium sulfate, potassium chloride, sodium chloride, sodium silicate, sodium nitrate, sodium acetate, triethanolamine, and methanol. The early strength agent mainly plays a role in improving early strength of the concrete of the base layer, such that development of the strength of the base layer exceeds development of the strength of the prestressed layer. Furthermore, by introducing K+ and Na+ ions into the concrete of the base layer, the early strength agent can increase the shrinkage of the concrete, such that the shrinkage of the base layer can be greater than that of the prestressed layer, or that the base layer shrinks but the prestressed layer expands.

The present disclosure will be further explained below in conjunction with specific embodiments, but it should not be understood as limiting the scope of protection of the present disclosure. Some non-essential improvements and adjustments made to the present disclosure by those skilled in the art based on the content of the present disclosure still fall within the scope of protection of the present disclosure.

Unless otherwise specified, the materials, reagents and so on mentioned below are commercially available products that are well known to those skilled in the art. Unless otherwise specified, the methods described are well-known methods in this field. Unless otherwise defined, all technical or scientific terms used herein have the same meaning as commonly understood by those of ordinary skill in the art.

### Embodiment 1

Mix proportions of the concrete of the base layer are as below: general purpose portland cement 400 kg, water 150 kg, gravels 980 kg, sand 680 kg, polycarboxylate water reducer 4 kg, ultrafine fly ash 100 kg, and sodium chloride 0.4 kg.

Mix proportions of the concrete of the prestressed layer are as below: general purpose portland cement 300 kg, water 198 kg, gravels 1080 kg, sand 680 kg, polycarboxylate water reducer 3 kg, fly ash 100 kg, polyether shrinkage reducing agent 0.4 kg, and calcium sulfoaluminate type expanding agent 3 kg.

In the forming method, first the concrete of the base layer is poured, then styrene-butadiene emulsion interfacial agent is sprayed on the surface of the concrete of the base layer, and then the concrete of the prestressed layer is poured. After the concrete is hardened and demoulded, there is formed the unreinforced prestressed concrete whose prestressed layer is under compression.

After testing, the shrinkage value of the concrete of the base layer in this embodiment is 450×10⁻⁶, and the shrinkage value of the concrete of the prestressed layer is 100×10⁻⁶. The shrinkage value of the concrete of the base layer is greater than that of the concrete of the prestressed layer, and a deformation value differential between the two shrinkage values is 350×10⁻⁶.

### Embodiment 2

The mix proportions of the concrete of the base layer are as below: general purpose portland cement 400 kg, water 150 kg, gravels 980 kg, sand 680 kg, naphthalene water reducer 4 kg, ultrafine slag 100 kg, and sodium sulfate 0.4 kg.

The mix proportions of the concrete of the prestressed layer are as below: general purpose portland cement 300 kg, water 198 kg, gravels 1080 kg, sand 680 kg, naphthalene water reducer 3 kg, slag 100 kg, polyalcohol shrinkage reducing agent 1 kg, and magnesium oxide-based expanding agent 10 kg.

In the forming method, first the concrete of the base layer is poured, after final set of the concrete of the base layer, the concrete of the base layer is subjected to surface roughening, acrylate copolymer emulsion is sprayed, and then the concrete of the prestressed layer is poured. After the concrete is hardened and demoulded, there is formed the unreinforced prestressed concrete whose prestressed layer is under compression.

After testing, the shrinkage value of the concrete of the base layer in this embodiment is 450×10⁻⁶, and the expansion value of the concrete of the prestressed layer is 75×10⁻⁶. The concrete of the base layer shrinks, the concrete of the prestressed layer expands, and a deformation value differential between the shrinkage value and the expansion value is 525×10⁻⁶.

### Embodiment 3

The mix proportions of the concrete of the base layer are as below: general purpose portland cement 400 kg, water 150 kg, gravels 980 kg, sand 680 kg, anthracene water reducer 4 kg, silica fume 100 kg, sodium nitrate 0.4 kg, polyether shrinkage reducing agent 0.5 kg, and iron powder series expanding agent 3 kg.

The mix proportions of the concrete of the prestressed layer are as below: general purpose portland cement 300 kg, water 198 kg, gravels 1080 kg, sand 680 kg, polycarboxylate water reducer 3 kg, stone powder 100 kg, polyether shrinkage reducing agent 1 kg, and iron powder series expanding agent 20 kg.

In the forming method, first the concrete of the base layer is poured, then steel fibers are vertically inserted into the concrete of the base layer and stubbles are exposed, and then the concrete of the prestressed layer is poured. After the concrete is hardened and demoulded, there is formed the unreinforced prestressed concrete whose prestressed layer is under compression.

After testing, the expansion value of the concrete of the base layer in this embodiment is 30×10⁻⁶, and the expansion value of the concrete of the prestressed layer is 96×10⁻⁶. The concrete of the base layer expands, and the concrete of the prestressed layer also expands, but the expansion of the concrete of the base layer is smaller than that of the concrete of the prestressed layer. A deformation value differential between the two expansion values is 66×10⁻⁶.

### Embodiment 4

The mix proportions of the concrete of the base layer are as below: general purpose portland cement 500 kg, water 150 kg, sand 880 kg, polycarboxylate water reducer 4 kg, ultrafine limestone powder 150 kg, potassium chloride 0.4 kg, polyalcohol shrinkage reducing agent 0.5 kg, lime-based expanding agent 1 kg, thickener 1 kg, and accelerating agent 1 kg.

The mix proportions of the concrete of the prestressed layer are as below: general purpose portland cement 450 kg, water 198 kg, sand 880 kg, polycarboxylate water reducer 4 kg, limestone powder 200 kg, polyalcohol shrinkage reducing agent 1 kg, magnesium oxide-based expanding agent 11 kg, thickener 1 kg, and accelerating agent 1 kg.

In the forming method, the concrete of the base layer is formed by means of 3D printing, then styrene-butadiene emulsion interfacial agent is sprayed on the surface of a printing paste, and then the concrete of the prestressed concrete printed. After the concrete is hardened and demoulded, there is formed the unreinforced prestressed concrete whose prestressed layer is under compression.

After testing, the shrinkage value of the concrete of the base layer in this embodiment is 580×10⁻⁶, and the shrinkage value of the concrete of the prestressed layer is 350×10⁻⁶. The shrinkage value of the concrete of the base layer is greater than that of the concrete of the prestressed layer, and a deformation value differential between the two shrinkage values is 230×10⁻⁶.

### Embodiment 5

The mix proportions of the concrete of the base layer are as below: general purpose portland cement 450 kg, water 150 kg, sand 880 kg, polycarboxylate water reducer 4 kg, ultrafine fly ash 150 kg, triethanolamine 0.4 kg, polyether shrinkage reducing agent 1 kg, iron powder series expanding agent 10 kg, thickener 1 kg, and accelerating agent 1 kg.

The mix proportions of the concrete of the prestressed layer are as below: general purpose portland cement 450 kg, water 198 kg, sand 880 kg, polycarboxylate water reducer 3 kg, steel slag powder 100 kg, polyalcohol shrinkage reducing agent 2 kg, lime-based expanding agent 20 kg, thickener 1 kg, and accelerating agent 1 kg.

In the forming method, the concrete of the base layer is formed by means of 3D printing, steel fibers are vertically inserted into the concrete of the base layer and stubbles are exposed, and then the concrete of the prestressed layer is printed. After the concrete is hardened, there is formed the unreinforced prestressed concrete whose prestressed layer is under compression.

After testing, the shrinkage value of the concrete of the base layer in this embodiment is 380×10⁻⁶, and the expansion value of the concrete of the prestressed layer is 60×10⁻⁶. The concrete of the base layer shrinks, the concrete of the prestressed layer expands, and a deformation value differential between the shrinkage value and the expansion value is 440×10⁻⁶.

### Embodiment 6

The mix proportions of the concrete of the base layer are as below: general purpose portland cement 465 kg, water 130 kg, sand 2 kg, gravels 2 kg, polycarboxylate water reducer 10 kg, ultrafine slag 100 kg, and potassium sulfate 10 kg.

The mix proportions of the concrete of the prestressed layer are as below: general purpose portland cement 420 kg, water 140 kg, sand 5 kg, gravels 5 kg, polycarboxylate water reducer 10 kg, limestone powder 145 kg, polyether shrinkage reducing agent 0.01 kg, and magnesium oxide-based expanding agent 0.4 kg.

In the forming method, first the concrete of the base layer is poured, then styrene-butadiene emulsion interfacial agent is sprayed on the surface of the concrete of the base layer and copper-coated steel fibers are spread, and then the concrete of the prestressed layer is poured. After the concrete is hardened and demoulded, there is formed an unreinforced prestressed concrete member whose prestressed layer is under compression.

After testing, the shrinkage value of the concrete of the base layer in this embodiment is 751×10⁻⁶, and the shrinkage value of the concrete of the prestressed layer is 462×10⁻⁶. The shrinkage value of the concrete of the base layer is greater than that of the concrete of the prestressed layer, and a deformation value differential between the two shrinkage values is 289×10⁻⁶.

### Embodiment 7

The mix proportions of the concrete of the base layer are as below: general purpose portland cement 80 kg, water 143 kg, sand 900 kg, gravels 700 kg, polycarboxylate water reducer 2 kg, ultrafine fly ash 400 kg, calcium sulfoaluminate type expanding agent 0.1 kg, and sodium silicate 2 kg.

The mix proportions of the concrete of the prestressed layer are as below: general purpose portland cement 110 kg, water 138 kg, sand 510 kg, gravels 1020 kg, polycarboxylate water reducer 2 kg, limestone powder 300 kg, polyether shrinkage reducing agent 40 kg, iron powder series expanding agent 100 kg, and potassium chloride agent 2 kg.

In the forming method, first the concrete of the base layer is poured, then surface galling is performed on the concrete of the base layer and the copper-coated steel fibers are spread, and then the concrete of the prestressed layer is poured. After the concrete is hardened and demoulded, there is formed the unreinforced prestressed concrete member whose prestressed layer is under compression.

After testing, the shrinkage value of the concrete of the base layer in this embodiment is 342×10⁻⁶, and the expansion value of the concrete of the prestressed layer is 62×10⁻⁶. The concrete of the base layer shrinks, the concrete of the prestressed layer expands, and a deformation value differential between the shrinkage value and the expansion value is 404×10⁻⁶.

In the concrete prepared in the embodiments 1 to 7, the differential obtained by subtracting the deformation value S1 of the base layer from the deformation value S2 of the prestressed layer is greater than 0, which indicates that compression is produced in the prestressed layer. That is, the prestress is produced in the prestressed layer.

A specific value of the prestress may be calculated based on the elastic modulus of the prestressed layer in specific embodiments. The elastic modulus of a general concrete is about 30 Gpa. When the poured materials are mortar and neat paste, their elastic moduli have wide range variations, and actual measurement shall prevail in specific operation.

The technical features in the claims and/or specification of the present disclosure may be combined, and their combination manners are not limited to combinations obtained through a reference relationship in the claims. The technical solutions obtained by combining the technical features in the claims and/or specification are also within the scope of protection of the present disclosure.

The above embodiments are merely preferred embodiments of the present disclosure, and are not intended to limit the present disclosure in any form. Any simple alterations or equivalent modifications and embellishments made to the above embodiments based on technical essences of the present disclosure should fall within the scope of the technical solutions of the present disclosure.

What is claimed is:

1. An unreinforced prestressed concrete comprising:
a base layer, wherein the base layer is a mortar, concrete or neat paste pouring piece, and the base layer has a deformation value S1; and
a prestressed layer disposed on a surface of the base layer and completely covering the base layer, wherein the prestressed layer is a mortar, concrete or neat paste pouring piece, and does not comprise a steel bar; interface treatment is carried out between the base layer and the prestressed layer; the interface treatment comprises spraying an emulsion-type interfacial agent at an interface or arranging metal fiber at the interface such that the metal fiber is inserted into the base layer and the prestressed layer simultaneously; and the prestressed layer has a deformation value S2, S1<S2.

2. The unreinforced prestressed concrete according to claim 1, wherein the base layer shrinks and the prestressed layer expands.

3. The unreinforced prestressed concrete according to claim 1, wherein the base layer shrinks, the prestressed layer shrinks, and shrinkage of the base layer is greater than shrinkage of the prestressed layer.

4. The unreinforced prestressed concrete according to claim 1, wherein the base layer expands, the prestressed layer expands, and expansion of the base layer is smaller than expansion of the prestressed layer.

5. The unreinforced prestressed concrete according to claim 1 sequentially comprising: a prestressed layer, a base layer, and a prestressed layer.

6. A method for forming the unreinforced prestressed concrete according to claim 1, wherein the method comprises:
forming the base layer; measured by weight percentage content, the base layer has a formula as follows: binding material cement 3.5%˜65%, water 6%˜20%, fine aggregate 0.2%˜54%, coarse aggregate 0%˜43%, water reducer 0.09%˜1.4%, ultrafine mineral admixture 4%˜18%, early strength agent 0.02%˜1.4%, expanding agent 0%˜0.7%, shrinkage reducing agent 0%˜0.06%, thickener 0%˜0.06%, and accelerating agent 0%˜0.06%; the deformation value of the base layer is represented by S1; and
forming the prestressed layer; measured by the weight percentage content, the base layer has a formula as follows: binding material cement 4.8%˜58%, water 6%˜20%, fine aggregate 0.6%˜54%, coarse aggregate 0%˜47%, water reducer 0.09%˜1.4%, admixture 4%˜20%, shrinkage reducing agent 0%˜2%, expanding agent 0.06%˜5%, thickener 0%˜0.06%, and accelerating agent 0%˜0.06%; the prestressed layer does not comprise a steel bar and completely covers the base layer; the deformation value of the prestressed layer is represented by S2; wherein S1<S2; and
the step of forming the unreinforced prestressed concrete further comprises carrying out interface treatment between the base layer and the prestressed layer; and the interface treatment comprises spraying an emulsion-type interfacial agent at an interface or arranging metal fiber at the interface such that the metal fiber is inserted into the base layer and the prestressed layer simultaneously.

7. The method according to claim 6, comprising:
1) forming the base layer;
2) pouring the prestressed layer on the base layer; and
3) after demoulding, exposing the prestressed layer for service.

8. The method according to claim 6, comprising:
1) forming the prestressed layer;
2) pouring the base layer on the prestressed layer; and
3) flipping after demoulding, such that the prestressed layer is exposed for service.

9. The method according to claim 6, comprising:
1) forming the prestressed layer;
2) pouring the base layer on the prestressed layer;
3) pouring the prestressed layer on the base layer; and
4) after demoulding, exposing the prestressed layer for service.

10. The method according to claim 6, wherein the binding material cement is selected from at least one of general purpose portland cement, special cement, and an air-hardening binding material.

11. The method according to claim 6, wherein the water reducer is selected from at least one of a polycarboxylate water reducer, a naphthalene water reducer, an anthracene water reducer, and a melamine water reducer.

12. The method according to claim 6, wherein the admixture is selected from at least one of fly ash, slag, stone powder, steel slag powder, and limestone powder.

13. The method according to claim 6, wherein the shrinkage reducing agent is at least one of a polyether or polyalcohol organic matter and a derivative thereof.

14. The method according to claim 6, wherein the expanding agent is selected from at least one of a calcium sulfoaluminate type expanding agent, a magnesium oxide-based expanding agent, a lime-based expanding agent, and an iron powder series expanding agent.

15. The method according to claim 6, wherein a specific surface area of the ultrafine mineral admixture is great than or equal to 500 m2/kg, and the ultrafine mineral admixture is selected from at least one of ultrafine slag, ultrafine cement, silica fume, ultrafine limestone powder, and ultrafine fly ash.

16. The method according to claim 6, wherein the early strength agent is selected from at least one of sodium sulfate, potassium sulfate, potassium chloride, sodium chloride, sodium silicate, sodium nitrate, sodium acetate, triethanolamine, and methanol.
